(19) United States
(12) Patent Application Publication
(10) Pub. No.: US 2017/0346283 A1
(43) Pub. Date: Nov. 30, 2017

(54) Systems and Methods for Modular DC Microgrids with Control of Loads

(71) Applicant: Massachusetts Institute of Technology, Cambridge, MA (US)

(72) Inventors: Wardah Inam, Boston, MA (US); David J. Perreault, Andover, MA (US); Rajeev J. Ram, Arlington, MA (US); Daniel DeWitt Strawser, Cambridge, MA (US)

(21) Appl. No.: 15/398,172

(22) Filed: Jan. 4, 2017

Related U.S. Application Data
(60) Provisional application No. 62/340,566, filed on May 24, 2016.

(51) Int. Cl. H02J 1/00; H02J 13/00; H02J 7/00

(52) U.S. Cl. CPC H02J 1/00; H02J 7/007; H02J 13/0003

(57) ABSTRACT

The systems and methods described herein are directed towards a microgrid having modular power management units to control and regulate power to maintain a stable energy environment and provide peer-to-peer electricity sharing within the microgrid. The microgrid includes a power source to generate power for the microgrid, a source power management unit coupled to the power source to receive the power, one or more load power management units coupled to the source power management unit to receive a portion of the power and a bi-directional communication system to couple the source power management unit to the one or more load power management units to control and allocate the power from the source power management unit to the one or more load power management units.

### CROSS-REFERENCE TO RELATED APPLICATION

The present application claims the benefit of U.S. Provisional Application 62/340,566, titled “MODULAR DC MICROGRIDS WITH CONTROL OF LOADS,” filed on May 24, 2016. The entire disclosure of which is hereby incorporated herein by reference in its entirety.

### BACKGROUND

The lack of electricity is one of the most pressing concerns in the developing world. Today, more than 1.2 billion people in the world do not have access to electricity and thus are denied a basic standard of living. This deficiency impedes many aspects of human development, such as health, education and economic development.

While there is a pressing need to provide electricity access, current technologies have not been able to scale to serve areas in need. In developing countries, grid electricity is often unreliable or entirely unavailable. The governments of these countries do not have the financial resources to increase generation to meet increasing demand, let alone to electrify off-grid areas. Further, grid extension to small and/or remote areas can be very expensive. Individual systems, such as solar home systems and diesel generators, have seen growth in recent years due to ease of deployment. However, these systems are still expensive to install and operate and may require complex financing solutions.

### SUMMARY

The systems and methods described herein are directed towards a microgrid (e.g., direct current (DC) microgrid) having modular power management units which connect through power and/or communication links to allocate power and control the shedding of load to maintain a stable energy environment within the microgrid. The modular power management units can be configured to provide peer-to-peer electricity sharing within the microgrid. With such an arrangement, the microgrid is a versatile system that can be implemented and adapted in a variety of different environments to create an electrical grid in previously off-grid and/or remote areas that may have not had access to electricity before.

The modular power management units may include one or more source power management units and one or more load power management units. The source power management units can be configured to maintain and control regulation of power within the microgrid and control load at each of the load power management units. The load power management units can be configured to control regulation of power to one or more external loads coupled to the respective load power management unit.

In an embodiment, the source power management unit may couple to one or more load power management units through the power and/or communication links to perform demand management for the microgrid. For example, the source power management unit can command and control the shedding of individual external loads coupled to each of the one or more load power management units. Thus, the source power management unit can ensure the microgrid operates within predetermined voltage and/or power limits to maintain the stable energy environment. The power and/or communication links can be bi-directional to allow communication between the source power management units and load power management units.

In an embodiment, one or more power generating sources (e.g., photovoltaic (PV) panels) and energy storage devices (e.g., batteries) may be coupled to the source power management unit to generate and provide power to the microgrid and to allow storing of excess power not used by the microgrid. The source power management unit can be configured to perform power conversion to provide the generated power at appropriate levels (e.g., voltage levels) for the various individual loads that may be coupled to the microgrid.

In some embodiments, the source power management unit can autonomously schedule and price power to provide reliable electricity to the load power management units. Thus, the microgrid may allow system and people to access electricity that previously were not able to afford power generating sources.

In an embodiment, the peer-to-peer electricity sharing microgrid described herein can enable scalable deployment of distributed power generation to provide affordable electricity in off-grid areas. In an embodiment, by managing the aggregated demand, resources can be optimally utilized to decrease the cost of generation and storage. The microgrid described herein can be scalable as it can be designed and built from the bottom up (e.g., beginning at individual load power management units) rather than depending on large centralized generation facility first. Thus, the microgrid described herein can provide more affordable and scalable electricity access.

In a first aspect, a microgrid system comprises a power source to generate power for the microgrid, a first source power management unit coupled to the power source to receive the power, one or more load power management units coupled to the first source power management unit to receive a portion of the power and a bi-directional communication system to couple the first source power management unit to the one or more load power management units to control and allocate the power from the first source power management unit to the one or more load power management units. In an embodiment, the first source power management comprises a source control unit, a source communication unit, a charge controller and a source converter. Each of the one or more load power management units comprises a load control unit, a load communication unit and a load converter.

In an embodiment, the power source further may comprise an energy storage device coupled to the charge controller of the first source power management unit. The energy storage device can store at least a portion of the power generated by the power generation unit.

In some embodiments, the source control unit can be coupled to each of the load control units through the bi-directional communication system to receive a load consumed value from each of the one or more load power management units and provide load commands to each of the one or more load power management units. The source control unit can determine a power threshold for the microgrid and each of the one or more load power management units. The source control unit can allocate the power to the one or more load power management units based at least on the power threshold and sheds load at each of the one or more load power management units based at least on the power threshold.

In an embodiment, the source control unit can generate and provide load commands to the source converter to modify the power received from the energy storage device. The source converter can modify the power received from the energy storage device to a predetermined level prior to the power being provided to the one or more load power management units. In some embodiments, the charge controller can charge the energy storage device of the power generation unit.

In an embodiment, the load converter converts the power received from the first source power management unit to one or more different voltage and/or power levels based at least on one or more external loads coupled to the respective load power management unit.

In an embodiment, the load control unit receives load commands from the source control unit through the bi-directional communication system and can modify a power value output to one or more external loads coupled to the respective load power management unit.

In some embodiments, the microgrid system may include a second source power management unit coupled to the first source power management unit and the one or more load power management units through the bi-directional communication system. The second source power management unit comprises a second source control unit, a second source communication unit, a second charger converter and a second source converter. The source control unit can receive current and voltage information from the second power management unit through the source communication unit.

In an embodiment, the microgrid may include a remote monitoring unit coupled to the first source power management unit to remotely monitor the microgrid and communicate load commands to the source control unit.

In another aspect, a method for controlling load for a microgrid comprises identifying a total load generated for the microgrid by a power generation unit, determining a load estimate at a source unit for one or more load units in the microgrid based at least on power characteristics of the one or more load units, generating a schedule for power to be allocated to the one or more load units in the microgrid based on the generated total load and load estimates for the one or more load units in the microgrid and allocating the power to the one or more load units based at least on the schedule.

In some embodiments, the method comprises determining the power characteristics for each of the one or more load units. The power characteristics of the one or more load units may include at least one of historical data, external loads coupled to the one or more load units and environmental conditions proximate to the one or more load units. The method may comprise updating the power characteristics of each of the one or more units using the historical data.

In some embodiment, the method may comprise transmitting a load consumed value by each of the one or more load units to the source unit through a bi-directional communication system between the one or more load units and the source unit. The method may comprise determining a load usage rate for each of the one or more load units.

In an embodiment, the method may comprise generating a first load command by the source unit for each of the one or more load units and generating a second load command by a respective load unit of one of the one or more load units for one or more external loads coupled to the respective load unit. The second load command can be based on the first load command and properties of the one or more external loads coupled to the respective load unit. The method may comprise instructing at least one of the one or more load units to shed load based on the schedule or to maintain a current load value.

### BRIEF DESCRIPTION OF THE DRAWINGS

The foregoing concepts and features may be more fully understood from the following description of the drawings. The drawings aid in explaining and understanding the disclosed technology. Since it is often impractical or impossible to illustrate and describe every possible embodiment, the provided figures depict one or more illustrative embodiments. Accordingly, the figures are not intended to limit the scope of the concepts, systems and techniques described herein. Like numbers in the figures denote like elements.

FIG. 1 is block diagram of a modular microgrid system;

FIG. 1A is a block diagram of a source power management unit;

FIG. 1B is a block diagram of a load power management unit;

FIG. 2 is a block diagram of a modular microgrid system coupled to a power source and an energy storage device;

FIG. 3 is a flow diagram of a method for controlling and regulating load in a microgrid; and

FIG. 4 is a flow diagram of a method for generating a power schedule for a microgrid.

### DETAILED DESCRIPTION

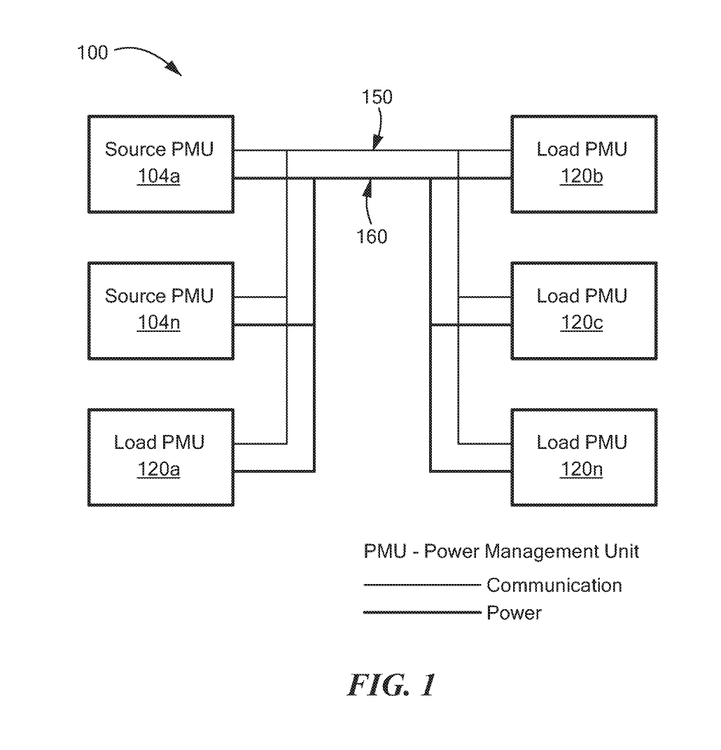

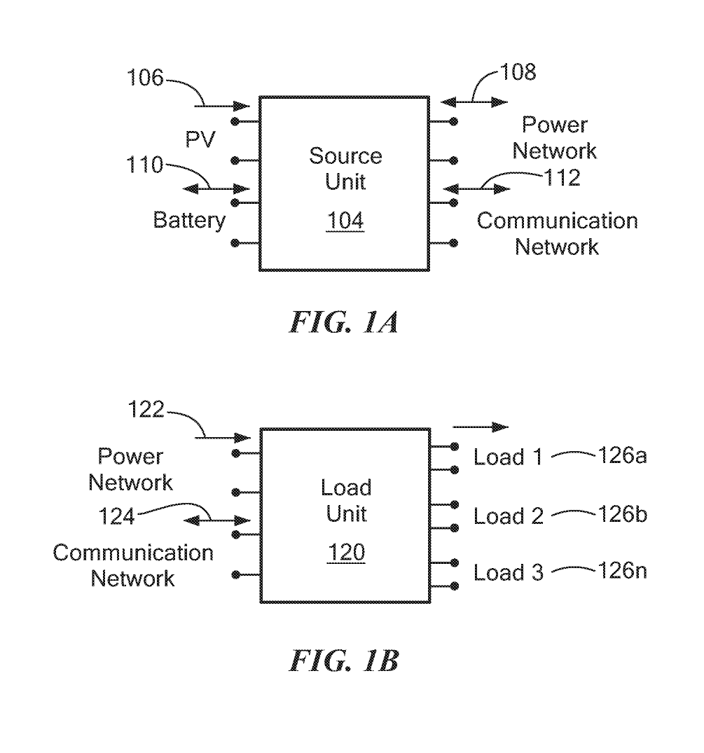

Now referring to FIG. 1, a modular microgrid 100 includes one or more source power management units 104a-104n coupled to one or more load power management units 120a-120n through a bi-directional communications system 150 and a bi-directional power network 160 to form the modular microgrid. Through the bi-directional communications system 150 and the bi-directional power network 160, the source power management units 104a-104n and the load power management units 120a-120n can communicate with each other and transfer information and/or power within the microgrid 100. In an embodiment, the source power management units 104a-104n can command and control the allocating or shedding of individual loads coupled to the load power management units 120a-120n. By allocating and/or shedding load at each of the load power management units 120a-120n, the source power management units 104a-104n can perform demand management for the modular microgrid 100 and operate microgrid within specified power and/or voltage thresholds.

The source power management units 104a-104n may include multiple ports to transfer and receive signals and/or power within microgrid 100. For example, and referring briefly to FIG. 1A, the source power management units 104a-104n may include three power ports. A first port 108 may be coupled to a power source to receive power for the microgrid. A second port 110 may be coupled to an energy storage device, such as a battery, to store power at the energy storage device and receive power from the power source. A third port 108 to couple to the bi-directional power network 160 to allow the source power management units 104a-104n to allocate power to the load power management units 120a-120n. In an embodiment, the bi-directional power network 160 may include an electrical infrastructure (e.g., cables, wires) to couple the source power management units 104a-104n to the load power management units 120a-120n. The components of the electrical infrastructure may include a variety of different sizes and types. For example, the components of the electrical infrastructure may be sized according to a power threshold of the microgrid 100 and/or demand values at each of the load power management units 120a-120n. For example, in one embodiment, the cable and/or wiring size and type may be different for different connections.

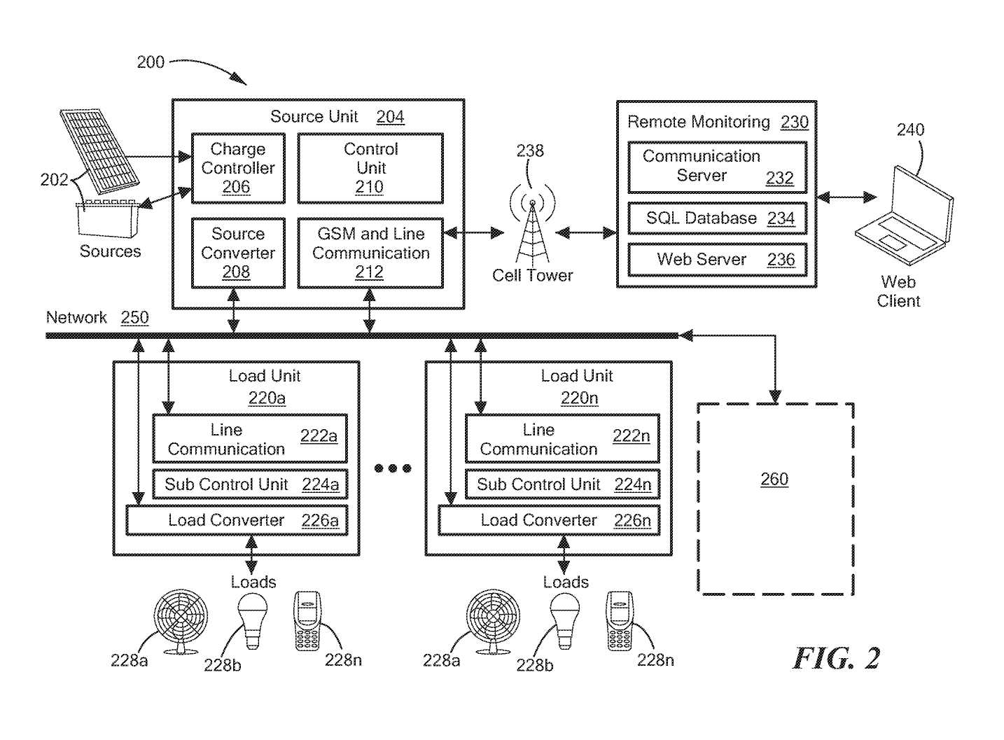

The source power management units 104a-104n may also include a fourth port 112 coupled to the bi-directional communications system 150 to establish a communication link between the source power management units 104a-104n and the load power management units 120a-120n. In an embodiment, the source power management units 104a-104n may transmit various commands to the load power management units 120a-120n and receive messages from the load power management units 120a-120n through the bi-directional communication network 150. In an embodiment, each of the second, third and fourth ports 110, 108, 112 can be bi-directional. The source power management units 104a-104n will be described in greater detail with respect to FIG. 2.

Now referring briefly to FIG. 1B, the load power management units 120a-120n may include one or more input ports 122a-122n and one or more output ports 126a-126n to transmit and receive signals and/or power within microgrid 100. The input ports 122a-122n may couple to the bi-directional power network 160 and/or the bi-directional communication network 150 to receive power and communications signals from the source power management units 104a-104n. For example, in some embodiments, the load power management units 120a-120n can receive and transmit power information to one or more of the source power management units 104a-104n through the bi-directional communication network 150. The load power management units 120a-120n will be described in greater detail with respect to FIG. 2.

Now referring to FIG. 2, a microgrid 200 includes a power source 202 and an energy storage device 203 coupled to a source power management unit 204. The source power management unit 204 is coupled to load power management units 202a-202n through a bi-directional communication system 250. In some embodiments, the source power management unit 204 may be coupled to a remote monitoring unit 230 through a network 238.

In an embodiment, the power source 202 can generate and provide power for the microgrid 200. For example, the power source 202 can generate electricity that is provided to microgrid 200. The power source 202 may include various types of power generating sources such as renewable energy power sources. For example, the power source 202 may include photovoltaic (PV) panels, wind turbine sources, micro-hydro sources and/or generators. The power source 202 can be configured to generate AC or DC power.

An output of the power source 202 is coupled to an input of the source power management unit 204 to provide the generated power. The source power management unit 204 may include a source control unit 210, a source communication unit 212, a charge controller 206 and a source converter 208. In an embodiment, the charge controller 206 may be used to couple to the energy storage device 203. For example, in some embodiments, when no energy storage device 203 is coupled to the source power management unit 204, the source power management unit 204 may not include the charge controller 206.

The source control unit 210 can be coupled to each of the load control units 224a-224n of the load power management units 220a-220n through the bi-directional communication system 250. The source control unit 210 can receive load consumed values from each of the load control units 224a-224n and provide load commands to the load control units 224a-224n.

In an embodiment, a load consumed value can include information regarding observed demand at the respective load control unit 224a-224n. For example, the information may include any statistical data that describes the demand (e.g., power demanded, power used) at the respective load control unit 224a-224n.

The load commands may include control decisions generated by the source power management unit 204 to instruct or encourage (e.g., incentivize) individual external loads 228-228n (e.g., users) at the respective load control unit 224a-224n to use more or less power. For example, the loads commands may include instructions to shed load at the load power management units 120a-120n and/or shed load at individual external loads 228-228n. Thus, load commands may indicate how much power the respective load control unit 224a-224n can be allocated, can use or that the source power management 204 would like to allocate to the respective load control unit 224a-224n.

The load commands may include incentives for users at the individual external loads 228-228n to shed load by offering variable pricing at different times. For example, the variable pricing may include a lower price for the power during typically low demand periods and higher price for the power during high demand periods. Thus, the variable pricing may encourage the users to reduce demand during typically high demand periods.

The source control unit 210 can generate power thresholds for the microgrid 200 and/or the load power management units 220a-220n. The power thresholds may be based on a total power generated by the power source 202 and/or pr-determined limits for the microgrid. The power threshold may include a power value that the microgrid 200 as a whole and/or the load power management units 220a-220n cannot exceed. The power threshold may vary depending on different time periods and/or conditions in an environment around the microgrid 200. For example, in some embodiments, the source control unit 210 may allocate power to one or more of the load power management units 220a-220n during certain time periods based power thresholds or shed load at one or more of the load power management units 220a-220n at different time periods based on the power thresholds.

The source control unit 210 may be coupled to the source converter 208. For example, the source control unit 210 can provide load commands to the source converter 208 to modify a voltage value and/or current value corresponding to the power received from the power source 203. The source converter 208 can be configured to convert the power received from the energy storage device 203 to a predetermined level prior to the power being provided to one or more of the load power management units 220a-220n. The source converter 208 can be configured to modify the voltage value and/or the current value to any appropriate value for the microgrid 200.

The charge controller 206 can be coupled to the energy storage device 203. The charge controller 206 can be configured to charge the energy storage device 203. The charge controller 206 may include any type of charge controller or charge regulator.

The source communication unit 212 can be configured to establish the link to the bi-directional communication system 250 for the source power management unit 204. The source communication unit 212 can use the bi-directional communication system 250 to transmit load commands to each of the load power management units 220a-220n and to receive information such as load consumed values and power characteristics from each of the load power management units 220a-220n. The source communication unit 212 can establish a communicate with the remote monitoring system or another source power management unit 260 (shown here in phantom) through the bi-directional communication system 250.

One or more outputs of the source power management unit 204 may be coupled to inputs of the one or more load power management units 220a-220n. The source power management unit 204 may be coupled to the one or more load power management units 220a-220n through the bi-directional communication system 250. In an embodiment, using the bi-directional communication system 250, the source power management unit 204 can allocate power to the load power management units 220a-220n and control power at the load power management units 220a-220n. Each of the load power management units 220a-220n may include a load control unit 224a-224n, a load communication unit 222a-222n and a load converter unit 226a-226n, respectively.

In an embodiment, the load control units 224a-224n can be coupled to the source control unit 210 and be configured to receive load commands from the source control unit 210 through the bi-directional communication system 250. The load control units 224a-224n can control, monitor and allocate power provided to one or more external loads 228a-228n coupled to the respective load power management unit 220a-220n. For example, in one embodiment, the load control units 224a-224n can modify (e.g., allocate load, shed load) a voltage value and/or current value provided to the one or more external loads 228a-228n. In some embodiments, the load control units 224a-224n can generate load commands to instruct and/or encourage the one or more external loads 228a-228n to modify a voltage value and/or current value corresponding to the power demand at the respective external load 228a-228n.

In an embodiment, the load converter units 226a-226n can be coupled to the source power management unit 204. For example, the load converter units 226a-226n can be coupled to the source control unit 210 and/or the source communication unit 212. The load converter units 226a-226n can be configured to convert the power received from the source power management unit 204 to one or more different voltage levels and/or current levels based at least on the power and/or voltage requirements of the one or more external loads 228a-228n coupled to the respective load power management unit 220a-220n. For example, each of the external loads 228a-228n may require a different power and/or voltage level. The load converter units 226a-226n can be configured to modify a voltage value and/or current value corresponding to the power needs of a respective external load 228a-228n to an appropriate voltage level and/or current level for the respective external load 228a-228n.

The load communication units 222a-222n can establish and control communications for their respective load power management unit 120a-120n. In an embodiment, the load communication units 222a-222n can be configured to establish a communications link with the source power management unit, one or more of the load power management units 220a-220n and or another source power management unit 260 (shown here in phantom) through the bi-directional communication system 250.

In an embodiment, the source power management unit 204 may be coupled to the remote monitoring system 230 through communications network 238. The remote monitoring system 230 may include a communication server 232, a database 234 and a web server 236. In some embodiments, the remote monitoring system 230 may be used to control components of the microgrid 200, for example and without limitation, to monitor and control functions of the source power management unit 204. In some embodiments, a system administrator can monitor and modify properties of the microgrid 200 through the remote monitoring system 230. For example, the power thresholds and/or schedules used to allocate power within the microgrid 200 can be modified through the remote monitoring system 230.

In an embodiment, the communication server 232 may be configured to establish a connection through the communications network 238 for one or more clients 240 to the source power management unit 204 to share and access information and data associated with the microgrid 200. In some embodiments, the one or more clients 240 may modify power thresholds within the microgrid 200 and/or generate and provide a power schedule to the microgrid through the communications server 232.

The database 234 may include a variety of different databases, look-up tables or other devices configured to store and organize data. In one embodiment, the database 234 may include or be provided as a structured query language (SQL) database. The server 236 may be configured to establish a connection to resources external to the microgrid 200. For example, the server 236 may provide a connection for the one or more clients 240 to access information such as weather forecasts in order to generate a power schedule for the microgrid 200.

In an embodiment, the bi-directional communication system 250 and communications network 238 may include wired or wireless connections to couple the components of microgrid 200 together. For example, in some embodiments, the bi-directional communication system 250 and communications network 238 may include an electrical infrastructure (e.g., system of cables and/or wires) to directly couple the source power management unit 204 to the one or more load power management units 220a-220n and/or the remote monitoring unit 230. In other embodiments, the bi-directional communication system 250 and communications network 238 may include a wireless connection to couple the source power management unit 204 to the one or more load power management units 220a-220n and/or the remote monitoring unit 230.

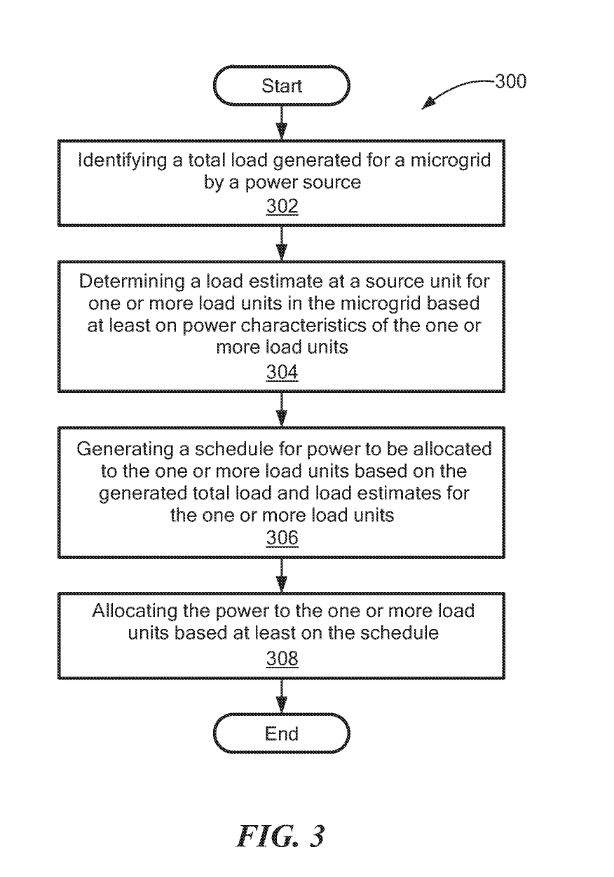

FIG. 3 a flow diagram showing illustrative processing that can be implemented within a microgrid and, more particularly, within a microgrid system, such as the illustrative systems described above in conjunction with FIGS. 1 and 2. Rectangular elements are herein denoted “processing blocks,” and represent computer software instructions or groups of instructions. Alternatively, the processing blocks may represent steps or processes performed by functionally equivalent circuits such as a digital signal processor circuit or an application specific integrated circuit (ASIC). The flow diagram does not depict the syntax of any particular programming language, but rather illustrates the functional information one of ordinary skill in the art requires to fabricate circuits or to generate computer software to perform the processing described. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered, meaning that, when possible, the functions represented by the blocks can be performed in any convenient or desirable order.

In FIG. 3, a method 300 for regulating power in a microgrid begins at block 302, where a total load generated for the microgrid by a power generation unit may be identified. In an embodiment, one or more power sources can be coupled to a microgrid to generate and provide power for the microgrid. The microgrid may include modular power management units coupled together through power and/or communication networks to form a modular microgrid. Power management units may include one or more source power managements units and one or more load power management units.

In an embodiment, the source power management units can be configured to control and regulate power within the microgrid. For example, the one or more power sources may be coupled to the source power management unit. The source power management unit can determine a total power amount generated by the one or more power sources and allocate that power to the one or more load power management units within the microgrid requesting power. The source power management unit can allocate power in different amounts or the same amount to the one or more load power management units. In some embodiments, the source power management unit can determine power thresholds for the microgrid based at least in part on the total power generated by the power sources and/or power demands of the load power management units.

The power sources may include various types of energy generating devices. For example, in some embodiments, the power sources may include renewable energy sources such as photovoltaic (PV) panels, wind turbines, and/or micro-hydro power sources.

In some embodiments, the power sources may be coupled to one or more energy storage devices. The power sources may transmit and store excess power (e.g., power not provided to the microgrid) in the energy storage devices. The energy storage devices may include various types of batteries.

In an embodiment, the source power management unit may be coupled to the energy storage device and can allocate excess power received from the power source to the energy storage device. The source power management unit may receive power from the energy storage device. In some embodiments, the microgrid may include multiple energy storage devices. The source power management unit can determine how to allocate the excess power to the different energy storage devices. In some embodiments, the source power management unit can determine which energy storage devices to receive power from when power is needed from the energy storage devices.

At block 304, a load estimate may be determined at a source power management unit for one or more load power management units in the microgrid based at least on power characteristics of the one or more load units. In an embodiment, the source power management unit can determine power characteristics for the one or more load power management units coupled to the microgrid. The load power management units may communicate with the source power management unit through a bi-directional communication system to provide their respective power characteristics and load demands. The source communications unit may transmit a request for the power characteristics and the load power management units may transmit a response to the source power management unit. In some embodiments, the load power management units may transmit the power characteristics in predetermined time intervals (e.g., daily, hourly, etc.).

The power characteristics may include historical data, number and types of external loads coupled to the different load power management units and environmental conditions proximate to the different load power management units. The historical data may include a history of past power demand (e.g., a power profile) of a load power management unit, including details such as timing of spikes in power demand and dips in power demand. The types of external loads may include characteristics of the type (e.g., cell phone, appliances, lighting, etc.) of external loads coupled to the load power management units and their specific power requirements.

The source power management unit may include a plurality of modules to communicate with the load power management units and to control and regulate power within the microgrid. In an embodiment, the source power management unit may include a source control unit, a source communication unit, a source charge controller and a source converter.

The source control unit can be configured to determine the total power generated by the power sources and determine power characteristics of the load power management units coupled to the microgrid for the source power management unit. In some embodiments, the source control unit can receive power information (e.g., current and/or voltage information) from the load power management units through the bi-directional communication system to determine current power usage amounts and/or requested power amounts for each of the load power management units. The power information may be based at least in part on one or more external loads coupled to each of the load power management units. In some embodiments, the source control unit may update the power characteristics of each of the load power management units using the received information from the respective load power management unit.

The source control unit can be configured to generate load commands and transmit the load commands to each of the load power management units through the bi-directional communication system. The load commands may include control decisions to instruct or encourage (e.g., incentivize) users at the respective load control unit to shed load or decrease current. Thus, load commands may indicate how much power the respective load power management units can be allocated based on a total power available to the microgrid, how much power the load power management units can use or that the source power management would like to allocate to the respective load power management unit.

In some embodiments, the load commands may encourage users at the individual external loads 228-228n to shed load by offering variable pricing. The variable pricing may include pricing based at least upon a specific time period and a historical demand value for that time period. For example, in one embodiment, the variable pricing may include a lower price for power during typically low demand periods and higher price for power during high demand periods. Thus, the variable pricing may encourage the users to reduce demand during typically high demand periods.

In an embodiment, the source charge controller can be configured to charge the energy storage device. The source converter can be configured to modify (e.g., step up, step down) a voltage and/or a current provided from the power source and/or the energy storage devices to a predetermined network voltage and/or current level. In some embodiments, the source converter can modify the voltage and/or current based on a control signal provided by the source control unit.

In an embodiment, the source communication unit can establish a communications link to the load power management units, the power source and the energy storage device for the source power management unit. For example, the source communications unit can communicate through the bi-directional communications system with the load power management units, the power source and the energy storage device to transmit and receive various commands, instructions and information.

Each of the load power management units may include multiple modules to communicate with the source power management unit and control and regulate power for one or more external loads coupled to the respective load power management unit. In an embodiment, each of the load power management units may include a load control unit, a load communication unit and a load converter.

The load control unit can receive and process load commands from the source power management unit received through the bi-directional communication system. The load control unit can be configured to generate and provide control signals to the load communication unit and load converter.

The load control unit can generate and transmit a load consumed value to the source power management unit through the bi-directional communication system. The load consumed value may include information regarding statistical properties of the power demand (e.g., electricity demand) at the respective load power management unit. For example, the load consumed value may include a total power used and/or a time schedule indicating when the power is used, when power demand increases and/or when power demand decreases.

The load converter can be configured to provide power conversion and regulation for the power received from the source power management unit. The load communication unit can be configured to establish a link to the bi-directional communication system such that the respective load power management unit can communicate with the source power management unit to provide various information, including, but not limited to, power characteristics.

At block 306, a schedule may be generated for power to be allocated to the one or more load units based on the generated total load and load estimates for the one or more load units.

The source power management unit may regulate the allocation of power between the one or more load power management units coupled to the microgrid to maintain a stable energy environment using the schedule. The schedules can be generated using a variety of different information, for example and without limitation, the schedule can be generated using power characteristics of each of the load power management units, the total power received from the power sources, power thresholds of the microgrid and/or of the individual load power management units, load forecasts and generation forecasts.

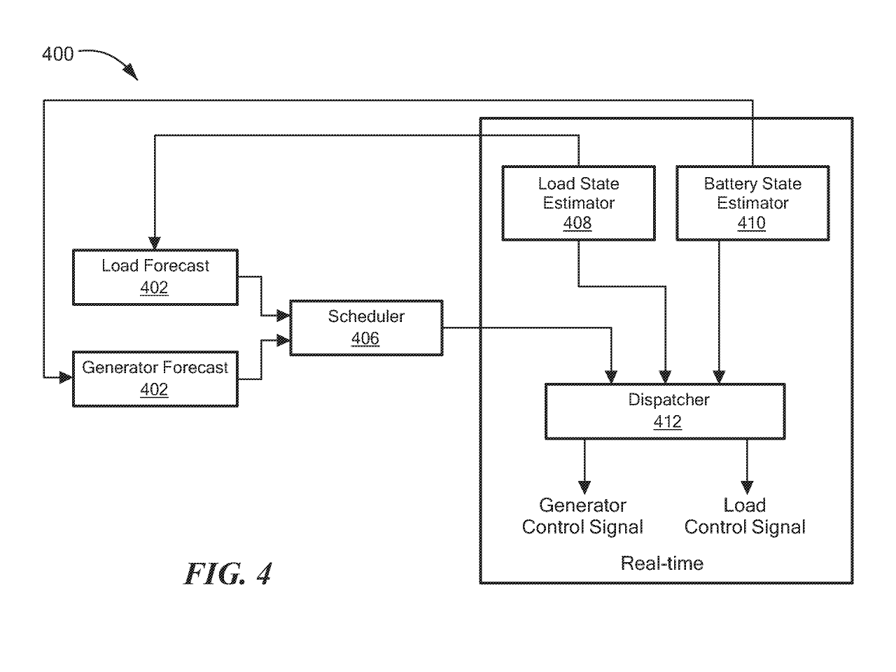

For example, and referring briefly to FIG. 4, a method for generating a schedule 400 may include providing a load forecast 402 and/or a generator forecast 404 to scheduling module 406. In some embodiments, the scheduling module 406 may be a component of a source control unit of the source power management unit. The load forecast 402 may include user activities and/or preferences (e.g., charging electronics, turning on lights) at the one or more load power management units. In some embodiments, the user activities can be included the power characteristics data received from each of the load power management units. The scheduling module 406 can store the user activities for each of the load power management units and update the schedule as more data is received. In some embodiments, the scheduling module 406 can continuously update the schedule based at least in part on the historical data and user preferences at the each of the load power management units.

The generator forecasts 404 may include previous weather forecasts, future weather forecasts and historical weather trends for an environment around the microgrid that may impact the generation of power. Thus, in some embodiments, the schedule can be generated based at least in part on the probability of certain weather conditions. For example, in one embodiment, the schedule can account for sunny versus cloudy days to account for the uncertainty of power generation on the cloudy days.

In an embodiment, the scheduling module 406 can provide a schedule to a dispatch module 412. In some embodiments, the dispatch module 412 may be a component of a source control unit of the source power management unit. The dispatch module 412 may allocate power from the source power management unit to the one or more load power management units based at least in part on the schedule.

In some embodiments, an input of the dispatch module 412 may receive load state estimates 408. The load state estimates 408 may be based at least in part on the load amounts determined by the load forecasts 402, however, the load state estimates 408 may provide an actual, current power demanded from the one or more load power management units. Thus, the dispatch module 412 can verify the amounts indicated in the schedule with the current power demands indicated in the load state estimates 408 to ensure the schedule is accurate. If the schedule is accurate, the dispatch module 412 may allocate power from the source power management unit to the one or more load power management units. If the schedule is not accurate, the dispatch module 412 may transmit load commands to instruct or encourage users at the one or more load power management units to shed load. In some embodiments, the dispatch module 412 may modify the schedule based at least in part on the current power demands indicated in the load state estimates 408.

In some embodiments, an input of the dispatch module 412 may receive battery state estimates 410. The battery state estimates may provide an actual state of charge of the battery. Thus, the dispatch module 412 can verify the amounts indicated in the schedule with the current available energy amounts (e.g., power amounts) indicated in battery state estimates 410 to ensure there is enough available energy to meets the amounts indicated in the schedule. If there is enough energy available to meet the amounts indicated in the schedule, the dispatch module 412 may allocate power from the source power management unit to the one or more load power management units. If there is not enough energy available to meet the amounts indicated in the schedule, the dispatch module 412 may transmit load commands to instruct or encourage users at the one or more load power management units to shed load. In some embodiments, the dispatch module 412 may modify the schedule based at least in part on the available energy amount.

Now referring back to FIG. 3, still at block 306, the schedule can indicate when and how much power is to be allocated to each of the load power management units. The schedule may include a power value to be allocated to each of the load power management units at specific times and/or over specific time periods (e.g., hourly time period, daily time period, etc.) The schedule may also include a schedule of when load commands are to be transmitted to each of the load power management units, for example, to instruct a respective load power management unit to shed load at one or more individual external loads at specific time and/or over a time period.

At block 308, power can be allocated to the one or more load units based at least on the schedule. In an embodiment, the source power management unit can allocate power to one or more of the load power management units using the schedule.

The source power management unit can allocate the power to the load power management units using the schedule. In an embodiment, the load power management units can allocate the received power to one or more external loads coupled to them. In some embodiments, a load converter may convert a voltage value and/or a current value corresponding to the received power to an appropriate voltage level and/or current level for one or more of the external loads.

In some embodiments, the power generated and/or allocated may vary depending on conditions in the environment around the microgrid. Thus, the schedule can be created and/or modified to account for the different environment conditions. For example, a first time period may represent day time and a second time period may represent night time. During the first time period, the power source may generate a first amount of power that is provided to the source power management unit and thus to the microgrid. The power source may include photovoltaic (PV) panels and may generate more power than the microgrid needs during the first time period. Therefore, a portion of the power generated may be provided to the source power management unit and the remaining power may be stored in the energy storage device. The schedule can indicate how much power is to allocated to the load power management units and how much is to be stored in the energy storage device. In some embodiments, the source power management unit may compare the total power generated to a predetermined threshold to determine how much power to store in the energy storage device.

In some embodiments, during the second time period, the power source may generate less power. For example, the second time period corresponds to nighttime and thus the photovoltaic (PV) panels do not produce power. The power and/or voltage level in the microgrid may fall below the predetermined threshold. In an embodiment, the energy storage device may provide power to the source power management unit to increase a power and/or voltage level within the microgrid to the predetermined threshold. The schedule may indicate how much power is to be received from the energy storage device during the second time period. The source power management unit can allocate the power to the load power management units using the schedule and the power from the energy storage device to the one or more load power management units.

In an embodiment, the source power management may generate a first load command for each of the load power management units coupled to the microgrid. The first load command may be generated based on the schedule and may include instructions to modify (e.g., shed) load at the respective load power management unit. In response to the first load command, the load control unit at the respective load power management unit may generate a second load command to modify a voltage level and/or a current level for one or more external loads coupled to the respective load power management unit. The second load command may include reducing power, de-energizing an external load or energizing an external load.

While the concepts, systems and techniques sought to be protected have been particularly shown and described with references to illustrated embodiments thereof, it will be understood by those skilled in the art that various changes in form and details may be made therein without departing from the spirit and scope of the concepts as defined by the appended claims.

Elements of different embodiments described herein may be combined to form other embodiments not specifically set forth above. Other embodiments not specifically described herein are also within the scope of the following claims.

What is claimed:

1. A microgrid system comprising:
a power source to generate power for the microgrid;
a first source power management unit coupled to the power source to receive the power, wherein the first source power management unit comprises:
a source control unit;
a source communication unit; and
a source converter, and
one or more load power management units coupled to the first source power management unit to receive a portion of the power, wherein each of the one or more load power management units comprises:
a load control unit;
a load communication unit; and
a load converter; and
a bi-directional communication system to couple the first source power management unit to the one or more load power management units to control and allocate the power from the first source power management unit to the one or more load power management units.

2. The system of claim 1, wherein the power source further comprises an energy storage device coupled to a charge controller of the first source power management unit, wherein the energy storage device stores at least a portion of the power generated by the power source.

3. The system of claim 1, wherein the source control unit is coupled to each of the load control units through the bi-directional communication system to receive a load consumed value from each of the one or more load power management units and provide load commands to each of the one or more load power management units.

4. The system of claim 1, wherein the source control unit determines a power output to the microgrid and a power threshold for each of the one or more load power management units.

5. The system of claim 4, wherein the source control unit allocates the power to the one or more load power management units based at least on the power threshold and sheds load at each of the one or more load power management units based at least on the power threshold.

6. The system of claim 2, wherein the source converter modifies power input to or output from the energy storage device to a predetermined level prior to the power being provided to the one or more load power management units.

7. The system of claim 2, wherein the charge controller charges the energy storage device of the power source.

8. The system of claim 1, wherein the load converter converts the power received from the first source power management unit to one or more different voltage levels based at least on one or more external loads coupled to the respective load power management unit.

9. The system of claim 1, wherein the load control unit receives load commands from the source control unit through the bi-directional communication system and modifies a power value output to one or more external loads coupled to the respective load power management unit.

10. The system of claim 1, further comprising a second source power management unit coupled to the first source power management unit and the one or more load power management units through the bi-directional communication system, wherein the second source power management unit comprising:
a second source control unit;
a second source communication unit;
a second charger converter, and
a second source converter.

11. The system of claim 10, wherein the second source control unit receives current and voltage information from the second power management unit through the source communication unit.

12. The system of claim 1, further comprising a remote monitoring unit coupled to the first source power management unit to remotely monitor the microgrid and communicate load commands to the source control unit.

13. A method for controlling load for a microgrid, the method comprising:
identifying total power generated for the microgrid by a power source;
determining a load estimate at a source unit for one or more load units in the microgrid based at least on power characteristics of the one or more load units;
generating a schedule for power to be allocated to the one or more load units in the microgrid based on the generated total load and load estimates for the one or more load units in the microgrid; and
allocating power to the one or more load units based at least on the schedule.

14. The method of claim 13, further comprising determining the power characteristics for each of the one or more load units, wherein the power characteristics of the one or more load units includes at least one of historical data, external loads coupled to the one or more load units and environmental conditions proximate to the one or more load units.

15. The method of claim 13, further comprising updating the power characteristics of each of the one or more units using the historical data.

16. The method of claim 13, further comprising transmitting a load consumed value by each of the one or more load units to the source unit through a bi-directional communication system between the one or more load units and the source unit.

17. The method of claim 13, further comprising determining a load usage rate for each of the one or more load units.

18. The method of claim 13, further comprising:
generating a first load command by the source unit for each of the one or more load units; and
generating a second load command by a respective load unit of one of the one or more load units for one or more external loads coupled to the respective load unit, wherein the second load command is based on the first load command and properties of the one or more external loads coupled to the respective load unit.

19. The method of claim 13, further comprising instructing at least one of the one or more load units to shed load based on the schedule or to maintain a current load value.
